(19) United States
(12) Patent Application Publication
(10) Pub. No.: US 2014/0176068 A1
(43) Pub. Date: Jun. 26, 2014

(54) Charging System, Electronic Apparatus, Charge Control Method, and Program

(71) Applicant: Kazuyuki Nishikawa, Kanagawa (JP)

(72) Inventor: Kazuyuki Nishikawa, Kanagawa (JP)

(73) Assignee: NEC CASIO MOBILE COMMUNICATIONS, LTD., Kanagawa (JP)

(21) Appl. No.: 14/241,867

(22) PCT Filed: Apr. 26, 2012
(86) PCT No.: PCT/JP2012/002855

§ 371 Date: Feb. 27, 2014

(30) Foreign Application Priority Data
Aug. 31, 2011 (JP) 2011-188737

(51) Int. Cl. H02J 7/02

(52) U.S. Cl. CPC H02J 7/025
USPC 320/108; 320/162

(57) ABSTRACT

A charging system, electronic apparatus, charge control method, and program applicable also to a movable-coil-type charging system are provided. A power receiving unit includes a charging section charging a secondary battery by using current induced in a power receiving coil; a charge state determining section monitoring a charge state of the secondary battery to determine whether charging of the secondary battery is required to be stopped; a command transmitting section stopping an operation of charging when determined that charging of the secondary battery is required to be stopped and transmitting a command to a power transmitting unit; a recharge determining section determining, while charging of the secondary battery is stopped, whether the secondary battery requires recharging; and a coupling releasing section temporarily releasing coupling of the power receiving coil and a power transmitting coil by electromagnetic induction when determined that the secondary battery requires recharging.

### TECHNICAL FIELD

The present invention relates to a non-contact-type charging system, electronic apparatus, charge control method, and program.

### BACKGROUND ART

A non-contact-type charging system transmits electric power from a first apparatus to a second apparatus for supply of electric power for the second apparatus and to charge a battery (a secondary battery) of the second apparatus, and is often used for various types of electronic apparatus operating with a battery. It is assumed that the first apparatus is referred to as a “power transmission side” and the second apparatus is referred to as a “power reception side”, and a coil is provided on each of the power transmission side and the power reception side. These coils correspond to a primary coil and a secondary coil of a transformer, so to speak. That is, by using the principle of electromagnetic induction coupling in which when flowing of an alternating current through the coil on the power transmission side (a primary coil) induces a current in the coil on the power reception side (a secondary coil), the induced current is converted into a direct current for supply electric power and charging the secondary battery.

Meanwhile, to prevent degradation of the secondary battery, measures against battery overcharging is indispensable. Overcharging refers to that an internal reaction (a chemical reaction) of a battery exceeds a reversible region to reach irreversible region. In the irreversible region, degradation of the battery proceeds rapidly. Therefore, in general, a function is provided for detecting a state prior to overcharging (a fully-charged state) and inhibiting further charging.

Patent Document 1 discloses a related technology in which when a secondary battery becomes in a fully-charged state, normal power transmission to the power reception side is stopped and power-save power transmission is performed with electric power lower than electric power at the time of normal power transmission. According to the technology, overcharging can be inhibited and, in addition, with low-power power transmission (power-save power transmission), replenishment for natural discharge of the secondary battery can be made, and electric power on the power reception side in operation (for example, standby power for a portable telephone) can be supplied.

Meanwhile, when natural discharge of the secondary battery or power consumption on the power reception side in operation is large, the power-save electric power is not enough, and discharge of the secondary battery proceeds, and therefore the secondary battery is required to be recharged. Regarding this point, for example, Patent Document 2 discloses a related technology in which, when an operation of recharging the secondary battery after full charging is performed, a power transmitting operation on the power transmission side is started at predetermined timing and, after the start of the power transmitting operation, the power transmitting operation is controlled based on a current flowing through the coil on the power transmission side. According to this technology, the secondary battery can be recharged every predetermined timing (for example, several hours).

Patent Document 3 also discloses a related technology in which power transmission from the power transmission side is stopped (charging is stopped) in response to a fully-charged command transmitted from the power reception side to the power transmission side indicating completion of charging and a charging restart check command for checking whether the power reception side requests recharging is transmitted to the power reception side in a charging-stopped state. According to this technology, overcharging can be inhibited, and recharging can be performed if necessary after it is checked whether recharging is required by transmitting a necessary command (a charging restart check command) to the power reception side.

Incidentally, technologies related to transmission of a command to be exchanged between the power reception side and the power transmission side are disclosed in, for example, Patent Document 3, Patent Document 4, and Patent Document 5, and their principle is such that electrical characteristics of one of the coil on the power transmission side and the coil on the power reception side are modulated with necessary data. For example, when a fully-charged command is transmitted from the power reception side to the power transmission side, electrical characteristics of the coil on the power reception side are modulated with data of the command. Alternatively, when a charging restart check command is transmitted from the power transmission side to the power reception side, electrical characteristics of the coil on the power transmission side are modulated with data of the command. In either case, the relevant command can be detected (received) from a change in current induced in the coil on the counterpart side.

Meanwhile, in the related technologies regarding recharging described above, that is, the related technologies for recharging at predetermined timing and the related technologies for recharging with a command response, the power transmission side and the power reception side have to keep a “predetermined positional relation”. The predetermined positional relation refers to a positional relation capable of causing electromagnetic induction and, in general, the state in which the power reception side is mounted on the power transmission side.

Patent Document 6 discloses a related technology of detecting that the power reception side is mounted on the power transmission side. According to the technology, it is detected that the power transmission side and the power reception side have a predetermined positional relation, and recharging can be performed.

As described above, by using the related technologies described in Patent Documents 1 to 6, it is possible to achieve a non-contact-type charging system that can prevent overcharging and can recharge as required.

Now, among non-contact-type charging systems, one called a “movable-coil-type” is present. In the movable-coil-type charging system, for example, as described in Patent Document 7 and Patent Document 8, the coil on the power transmission side is made as a movable type (a mechanism capable of actively moving), detecting the mount position of the power reception side mounted on the power transmission side, moving the coil to the mount position for power transmission, and returning the coil to a home position (an initial position) after full charging. According to the charging system, a plurality of power reception sides can be mounted on the power transmission side, and therefore a charging system with high versatility can be achieved.

### PRIOR ART DOCUMENTS

### Patent Documents

Patent Document 1: JP 2008-206232
Patent Document 2: JP 2008-236968
Patent Document 3: JP 2010-035417
Patent Document 4: JP 2010-246292
Patent Document 5: JP 2010-252517
Patent Document 6: JP 2011-010384
Patent Document 7: JP 2009-247194
Patent Document 8: JP 2010-263663

### SUMMARY OF INVENTION

### Problem to be Solved by the Invention

However, this movable-coil-type charging system has the following inconveniences in view of recharging.

(1) Since the coil returns to the home position after full charging, a recharging command cannot be transmitted, and therefore recharging cannot be made.
(2) Although the drawback as mentioned in (1) can be solved by moving the coil on the power transmission side regularly (such as once an hour) to the position on the power reception side, recharging cannot be performed at least until the coil is moved, and therefore quick recharging cannot be performed.

Thus, an object of the present invention is to provide a charging system, electronic apparatus, charge control method, and program applicable also to a movable-coil-type charging system.

### Means for Solving the Problem

A charging system of the present invention comprises a power transmitting unit including a power transmitting coil and a power receiving unit including a power receiving coil that can be coupled to the power transmitting coil by electromagnetic induction,

the power transmitting unit including

power transmitting means driving the power transmitting coil when the power receiving coil is positioned near the power transmitting coil and transmitting electric power to the power receiving coil,

command receiving means receiving a predetermined command transmitted from the power receiving unit, and

stopping means stopping a power transmitting operation of the power transmitting means when the predetermined command is received, and

the power receiving unit including

charging means charging a secondary battery by using a current induced in the power receiving coil,

fully-charged state determining means monitoring a charge state of the secondary battery to determine whether the secondary battery is in a fully-charged state,

command transmitting means stopping the charging means from performing an operation of charging the secondary battery when it is determined by the fully-charged state determining means that the secondary battery is in the fully-charged state and transmitting the predetermined command to the power transmitting unit,

recharge determining means determining, while charging of the secondary battery is being stopped, whether the secondary battery is in a state requiring recharging, and

cutoff means temporarily cutting off the power receiving coil from a circuit when it is determined by the recharge determining means that the secondary battery is in the state requiring recharging.

An electronic apparatus of the present invention comprises

a power receiving coil that can be coupled to a power transmitting coil of a power transmitting unit by electromagnetic induction,

charging means charging a secondary battery by using a current induced in the power receiving coil,

fully-charged state determining means monitoring a charge state of the secondary battery to determine whether the secondary battery is in a fully-charged state,

command transmitting means stopping the charging means from performing an operation of charging the secondary battery when it is determined by the fully-charged state determining means that the secondary battery is in the fully-charged state and transmitting to the power transmitting unit a command for making an instruction for stopping electric power transmission,

recharge determining unit determining, while charging of the secondary battery is being stopped, whether the secondary battery is in a state requiring recharging, and

cutoff means temporarily cutting off the power receiving coil from a circuit when it is determined by the recharge determining means that the secondary battery is in the state requiring recharging.

A charge control method of the present invention comprises

a charging step of charging a secondary battery by using a current induced in a power receiving coil;

a fully-charged state determining step of monitoring a charge state of the secondary battery to determine whether the secondary battery is in a fully-charged state;

a command transmitting step of stopping the charging step from performing an operation of charging the secondary battery when it is determined in the fully-charged state determining step that the secondary battery is in the fully-charged state and transmitting a command making an instruction for stopping a power transmitting unit from transmitting electric power;

a recharge determining step of determining whether the secondary battery is in a state requiring recharging while charging of the secondary battery is being stopped; and

a cutoff step of temporarily cutting off the power receiving coil from a circuit when it is determined in the recharge determining step that the secondary batter is in the state of requiring recharging.

A program of the present invention provides functions to a computer of a power receiving unit having a power receiving coil that can be coupled to a power transmitting coil of a power transmitting unit by electromagnetic induction, the function comprising:

charging means charging a secondary battery by using a current induced in the power receiving coil,

fully-charged state determining means monitoring a charge state of the secondary battery to determine whether the secondary battery is in a fully-charged state,

command transmitting means stopping the charging means from performing an operation of charging the secondary battery when it is determined by the fully-charged state determining means that the secondary battery is in the fully-charged state and transmitting to the power transmitting unit a command for making an instruction for stopping electric power transmission,

recharge determining unit determining whether the secondary battery is in a state requiring recharging while charging of the secondary battery is being stopped, and

cutoff means temporarily cutting off the power receiving coil from a circuit when it is determined by the recharge determining means that the secondary battery is in the state requiring recharging.

### Effect of the Invention

According to the present invention, it is possible to provide a charging system, electronic apparatus, charge control method, and program applicable also to a movable-coil-type charging system.

### BRIEF DESCRIPTION OF DRAWINGS

FIG. 1 is an external view of a movable-coil-type charging system.

FIG. 2 is a conceptual structural diagram of an array sensor coil 6.

FIG. 3 is a structural diagram of a power transmitting unit 2 and a power receiving unit 3.

FIG. 4 is a structural diagram of a power reception circuit 18.

FIG. 5 is a diagram depicting schematic operation flows of an embodiment.

FIG. 6 is a structural diagram of Supplemental Note 1.

### DESCRIPTION OF EMBODIMENTS

An embodiment of the present invention is described below with reference to the drawings by taking an application to a non-contact-type and movable-coil-type charging system as an example.

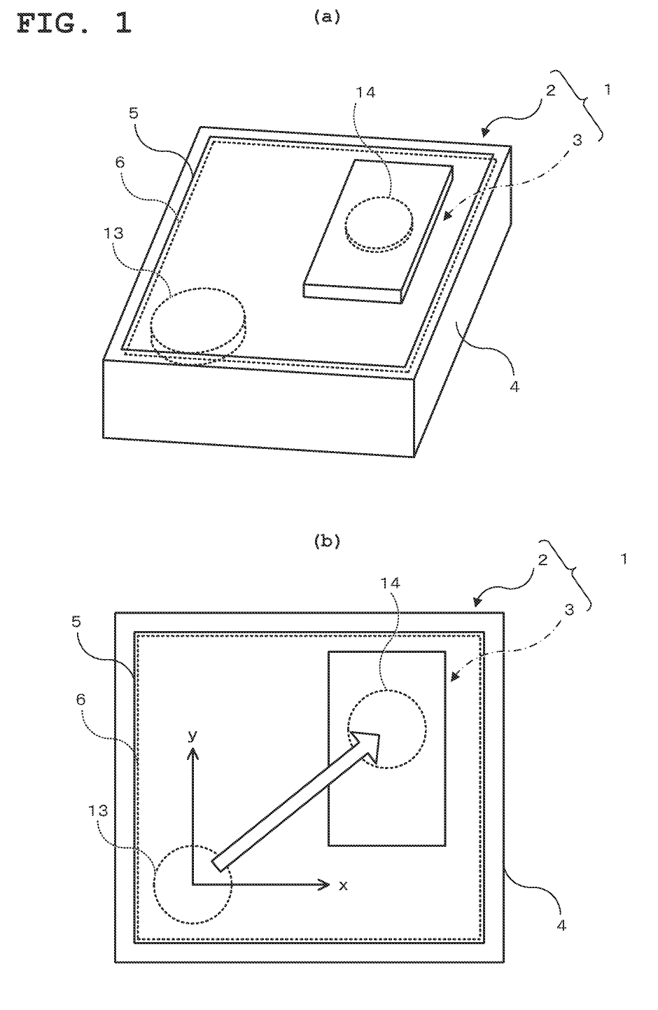

FIG. 1 is an external view of a movable-coil-type charging system. In this drawing, a movable-coil-type charging system 1 is configured of a power transmitting unit 2 and at least one power receiving unit 3. The power transmitting unit 2 corresponds to the “power transmission side” at the outset, and the power receiving unit 3 corresponds to the “power reception side” at the outset. The power receiving unit 3 is any electronic apparatus operating with a secondary battery, for example, a portable telephone such as a smartphone, but is not limited thereto. Any electronic apparatus can be used as long as it supports a non-contact-type and movable-coil-type charging system.

The power transmitting unit 2 may be read as a charger or a charge stand. The power transmitting unit 2 includes a rectangular plate 5 for mounting the power receiving unit 3 on a main surface (an upper-side surface in the drawing) of a flat-box-shaped casing 4, and this plate 5 has an appropriate size so as to allow a plurality of power receiving units 3 to be arranged and mounted. Straight below the plate 5, detecting means for detecting a mount position of the power receiving unit 3 mounted on this plate 5 (accurately, the position of a coil 14 and, for convenience of description, referred to as the mount position of the power receiving unit 3 in the following). This detecting means can be configured of, for example, the array sensor coil 6.

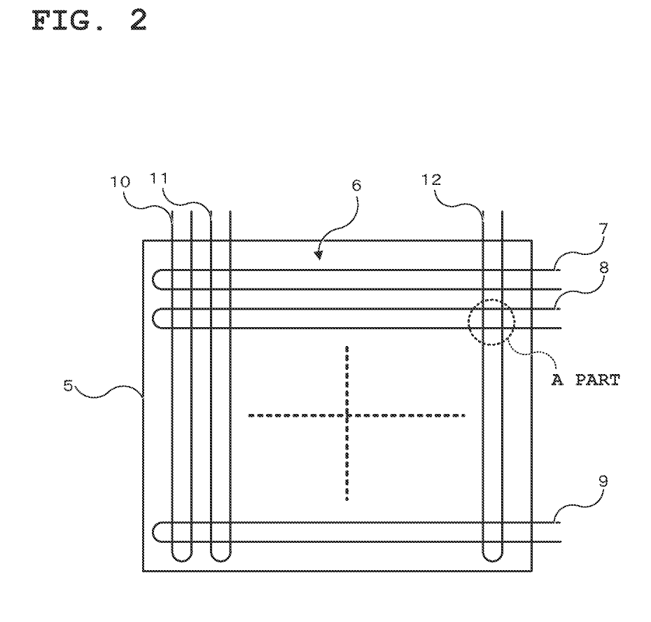

FIG. 2 is a conceptual structural diagram of the array sensor coil 6. In this drawing, the array sensor coil 6 is configured of n lateral-direction coils 7 to 9 arranged in parallel with a lateral side of the plate 5 and m vertical-direction coils 10 to 12 arranged in parallel with a vertical side of the plate 5 so that the coils cross each other. n and m are each an integer at least equal to or larger than 2, and n=m or n≠m.

When the lateral-direction coils 7 to 9 and the vertical-direction coils 10 to 12 are paired and sequentially driven in an alternating manner, the mount position of the power receiving unit 3 can be detected from a change in drive current. For example, when a predetermined change in its current is detected when a pair of the coil 8 and the coil 12 is driven, a position of a point of intersection of these coil 8 and coil 12 (A PART in the drawing) can be detected as a mount position of the power receiving unit 3.

Referring back to FIG. 1, the power transmitting unit 2 includes the array sensor coil 6 on a lower surface side of the plate 5 and further includes a movable-type power transmitting coil 13 (hereinafter simply referred to as a power transmitting coil 13) therebelow. Also, the power receiving unit 3 includes therein a power receiving coil 14 fixed in position (hereinafter simply referred to as a power receiving coil 14).

The power transmitting coil 13 is configured so as to be able to move freely in a vertical side direction (y-axial direction) and a lateral side direction (x-axial direction) of the plate 5 and a mixed direction thereof by a driving mechanism not shown. A home position of the power transmitting coil 13 is at a predetermined position defined in advance, for example, a position at a lower-left corner of the plate 5. When the mount position of the power receiving unit 3 is detected by the array sensor coil 6, this power transmitting coil 13 moves from the home position toward the mount position.

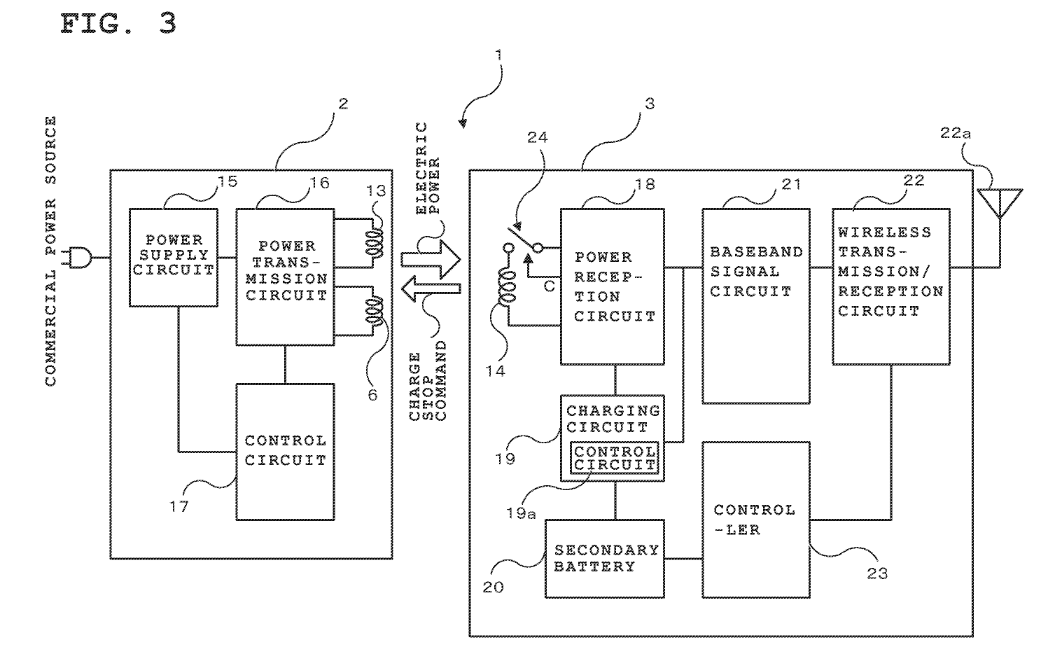

FIG. 3 is a structural diagram of the power transmitting unit 2 and the power receiving unit 3. In this drawing, firstly, the power transmitting unit 2 includes the array sensor coil 6 and the power transmitting coil 13, and further includes a power supply circuit 15, a power transmission circuit 16, and a control circuit 17.

The function of each unit of the power transmitting unit 2 is as follows.

### (Power Supply Circuit 15)

The power supply circuit 15 generates various power supply voltages required for a power transmitting operation based on a commercial power supply. Various power supply voltages include an operating voltage of each unit, power for moving the power transmitting coil 13, power-transmission electric power to be sent to the power receiving unit 3 via the power transmitting coil 13, and driving power for the array sensor coil 6.

### (Power Transmission Circuit 16)

The power transmission circuit 16 has a first function of driving the array sensor coil 6 to detect whether the power receiving unit 3 is mounted on the plate 5 and, when the detection result is positive, detecting a mount position of the power receiving unit 3, a second function of moving the power transmitting coil 13 from the home position to the mount position of the power receiving unit 3 and also returning the power transmitting coil 13 to the home position after completion of charging, a third function of driving the power transmitting coil 13 moved to the mount position of the power receiving unit 3 to send electric power to the power receiving unit 3, and a fourth function of receiving a charge stop command (or a fully-charged state command) transmitted as appropriate from the power receiving unit 3.

### (Control Circuit 17)

The control circuit 16 is a control element of a program control type configured mainly of a computer, controlling the power supply circuit 15 and the power transmission circuit 16 described above by following a control program set in advance to execute the function of each unit.

Next, the power receiving unit 3 includes the power receiving coil 14 described above, and further includes a power reception circuit 18, a charging circuit 19, a secondary battery 20, a baseband signal circuit 21, a wireless transmission/reception circuit 22, and a controller 23.

The function of each unit of the power receiving unit 3 is as follows.

### (Power Reception Circuit 18)

The power reception circuit 18 has a first function of rectifying a current induced in the power receiving coil 14 for conversion to a direct-current voltage and supplying the direct-current voltage to the charging circuit 19, a second function of modulating electrical characteristics of the power receiving coil 14 in response to a charge stop signal (or a full charge signal) sent as appropriate from the charging circuit 19 and transmitting a charge stop command (or a fully-charged command) to the power transmitting unit 2 and, furthermore, a third function of electrically cutting off the power receiving coil 14 from the charging circuit 18 at predetermined timing.

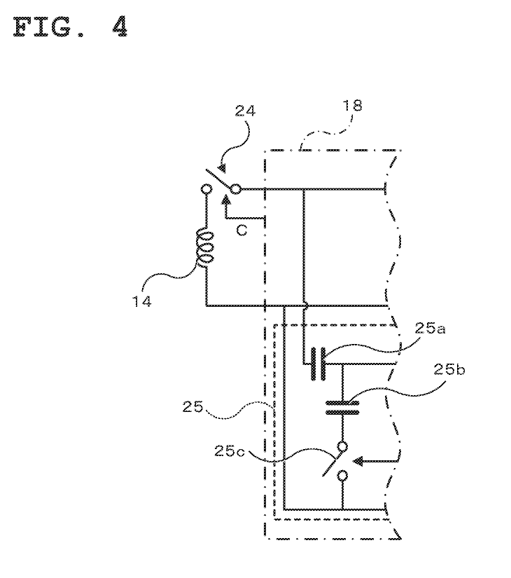

FIG. 4 is a structural diagram of the power reception circuit 18. As depicted in the drawing, the power reception circuit 18 includes cutoff means 24 and a resonant circuit 25. The resonant circuit 25 is an element for achieving the second function, and the cutoff means 24 is an element for achieving the third function.

The resonant circuit 25 is configured to include, for example, a first capacitor 25a connected to one end of the power receiving coil 14 and a second capacitor 25b and a switch 25c inserted between one end of the first capacitor 25a and the ground. By turning the switch 25c ON and OFF, electrical characteristics of the power receiving coil 14 can be changed. By controlling an ON/OFF period of the switch 25c, the electrical characteristics of the power receiving coil 14 can be modulated with a necessary command (a charge stop command or a fully-charged command) (achieving the second function).

The cutoff means 24 can be configured of, for example, a switch element inserted in the coil 24 in series. The switch element may be any as long as it turns ON and OFF in response to a control signal C and, for example, a mechanical relay or a transistor switch can be used.

The cutoff means 24 becomes in an ON state when the control signal C is inactive (non-cutoff instruction), and connects both ends of the power receiving coil 14 to the power reception circuit 18. When the control signal C is active (cutoff instruction), the cutoff means 24 becomes in an OFF state, and electrically cuts off one end of the power receiving coil 14 (an end on a side where the cutoff means 24 is inserted) to cut the connection with the power reception circuit 18 (achieving the third function).

When the state is assumed to be referred to as a “cutoff state”, the power receiving coil 14 in the cutoff state no longer achieves a function as a “coil” (a function such as a secondary coil of a transformer), and therefore the power transmission circuit 16 of the power transmitting unit 2 does not detect the mount of the power receiving unit 3. In more detail, even if the power receiving unit 3 is actually mounted on the plate 5 of the power transmitting unit 2, the power receiving unit 3 with the power receiving coil 14 cut off is a so-called simple box without a power receiving function. Therefore, in this case, the power transmission circuit 16 of the power transmitting unit 2 does not detect the presence (that is, the mount) of the power receiving unit 3, and makes a deemed determination as if the power receiving unit 3 had been removed from the top of the plate 5.

In general, in a non-contact-type charging system, charging starts when the power receiving unit 3 is mounted on the power transmitting unit 2, and charging stops when the mount state is released (that is, when the power receiving unit 3 is removed). Then, charging starts when the power receiving unit 3 is again mounted on the power transmitting unit 2, and charging stops when the mount state is released. This operation is repeated until full charge. As such, charging in the non-contact-type charging system can start and stop only with a simple operation of mounting and removing the power receiving unit 3.

The cutoff means 24 is an element for making a pseudo-execution of the operation. That is, when the cutoff means 24 is turned ON (the control signal C is inactive), this is equivalent to the state in which the power receiving unit 3 is mounted and, when the cutoff means 24 is turned OFF (the control signal C is inactive), this is equivalent to the state in which the power receiving unit 3 is removed. With ON/OFF control of the cutoff means 24, the mount and removal of the power receiving unit 3 can be reproduced. However, note that this removal is of a “pseudo” type. While in fact the power receiving unit 3 is mounted on the plate 5 of the power transmitting unit 2, the power receiving coil 14 is electrically cut off, and therefore the state can be regarded as if the power receiving unit 3 had “been removed”.

### (Charging Circuit 19)

The charging circuit 19 has a first function of charging the secondary battery 20 with electric power from the power reception circuit 18, a second function of monitoring a charge state of the secondary battery 20 and, when detecting a fully-charged state before overcharging, stopping charging the secondary battery 20 and outputting a charge stop signal (or a fully-charged signal) to the power reception circuit 18, and, furthermore, a third function of making an instruction for once turning the cutoff means 24 OFF with respect to the power reception circuit 18 when the secondary battery 20 is required to be recharged while charging of the secondary battery 20 is being stopped and then turning the cutoff means ON again (making the control signal C inactive→active→inactive). To achieve these first to third functions, the charging circuit 19 includes a control circuit 19a configured of a program-control-type computer executing a control program set in advance.

### (Secondary Battery 20)

The secondary battery 20 is a power supply element that can be charged for supplying operating electric power of each unit (the power reception circuit 18, the charging circuit 19, the secondary battery 20, the baseband signal circuit 21, the wireless transmission/reception circuit 22, and the controller 23) and, for example, a battery such as a nickel-cadmium battery.

### (Baseband Signal Circuit 21 and Others)

The baseband signal circuit 21 is a load element operating together with the wireless transmission/reception circuit 22 and the controller 23 upon reception of electric power supply from the secondary battery 20. These load elements (the baseband signal circuit 21, the wireless transmission/reception circuit 22, and the controller 23) are those, for example, when a portable telephone such as a smartphone is taken as the power receiving unit 3. That is, the baseband signal circuit 21 generates and outputs a voice signal of the portable telephone as a baseband signal. Also, the wireless transmission/reception circuit 22 spatially radiates the baseband signal from an aerial wire 22a over a predetermined high-frequency signal and demodulates the high-frequency signal received from the aerial wire 22a to the baseband signal for output to the baseband signal circuit 21. Furthermore, the controller 23 is a program-control-type control element configured mainly of a computer, and controls operations required for the portable telephone in a centralized manner by following a control program set in advance. Therefore, these load elements are not limited to those depicted in the drawings. Any load element complying with the functions of the power receiving unit 3 can be used.

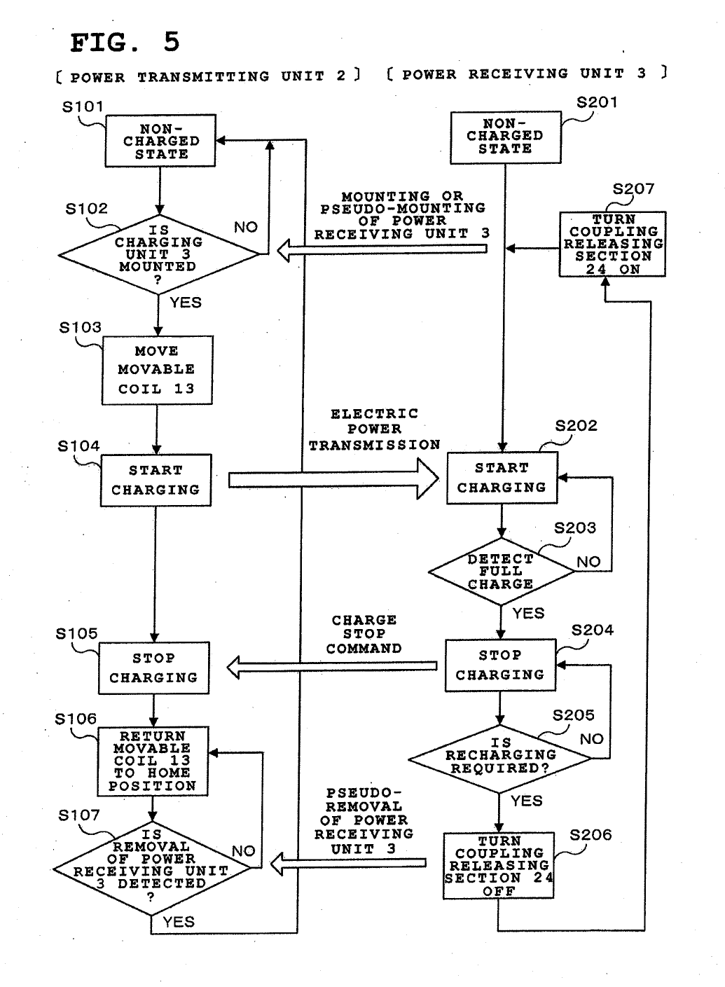

FIG. 5 is a diagram depicting schematic operation flows of the embodiment. In this drawing, a flow on the left side depicts an operation flow of the power transmitting unit 2, and a flow on the right side depicts an operation flow of the power receiving unit 3. Also, bold arrows connecting the left and right flows each represent a signal exchange or state exchange from one flow to the other flow.

First, in an initial state, the power transmitting unit 2 and the power receiving unit 3 are both in a non-charge state (Step S101 and Step S201). That is, the power transmitting unit 2 is in a power transmission standby state, and the power receiving unit 3 is in a power supply off state or a predetermined standby state (in the case of a portable telephone, an incoming call standby state). Here, both are at locations away from each other, and the power receiving unit 3 is not mounted on the plate 5 of the power transmitting unit 2. During this state, the power transmitting unit 2 continuously determines whether the power receiving unit 3 is mounted on the plate 5 (Step S102).

When the determination result at Step S102 becomes “YES”, that is, when it is determined that the power receiving unit 3 is mounted on the plate 5 of the power transmitting unit 2, the power transmitting unit 2 drives the array sensor coil 6 to detect the mount position of the power receiving unit 3 and also move the power transmitting coil 13 to the mount position (Step S103) to start charging (Step S104).

Here, with the cutoff means 24 being in an ON state, the power receiving unit 3 converts a current induced in the power receiving coil 14 to a direct current voltage, and uses the direct current voltage to start an operation of charging the secondary battery 20 (Step S202). Thereafter, the power receiving unit 3 monitors the charge state of the secondary battery 20 to determine whether the secondary battery 20 is in a fully-charged state (Step S203).

Then, when the secondary battery 20 is not in a fully-charged state, the power receiving unit 3 continues the charging operation. On the other hand, when the secondary battery 20 is in a fully-charged state, the power receiving unit 3 stops charging the secondary battery 20 and also transmits a charge stop command (or a fully-charged command) to the power transmitting unit 2 (Step S204).

In response to this command reception, the power transmitting unit 2 stops the operation of charging the power receiving unit 3 (Step S105) and also returns the power transmitting coil 13 to the home position (Step S106).

Then, the power transmitting unit 2 determines removal of the power receiving unit 3 (Step S107). When the power transmitting unit 2 does not determine removal, the procedure repeats Step S105 onward. On the other hand, when the power transmitting unit 2 determines removal, the procedure returns to Step S101, repeating the operations described above.

Here, the power receiving unit 3 determines whether the secondary battery is in a state requiring recharging, that is, in a state in which natural discharge of the secondary battery 20 has proceeded, or in a state in which the charged amount of the secondary battery 20 is decreased due to power consumption of the load elements (the baseband signal circuit 21, the wireless transmission/reception circuit 22, and the controller 23) operating upon reception of power supply from the secondary battery 20 (Step S205). When it is determined that the secondary battery 20 is in a state requiring recharging (determination of “YES” at Step S205), an operation is performed such that the control signal C is set as active from inactive and the cutoff means 24 is turned OFF (Step S206) and then the control signal C is set as inactive from active and the cutoff means 24 is turned ON again (Step S207).

The operation of the embodiment is described as above.

Next, effects of the present embodiment are described.

A point of the embodiment is that when the state requiring recharging is determined by the power receiving unit 3 (determination of “YES” at Step S205), the control signal C is set as active from inactive and the cutoff means 24 is turned OFF (Step S206) and then the control signal C is set as inactive again from active and the cutoff means 24 is turned ON (Step S207). With this point, recharging can be performed without requiring a special command (a recharging command).

This is because the power receiving coil 14 can be electrically cut off by turning the cutoff means 24 OFF, the state in which the power receiving unit 3 is removed from the top of the plate 5 of the power transmitting unit 2 can be reproduced in a pseudo manner. Furthermore, by turning the cutoff means 24 ON, the connection of the power receiving coil 14 can be returned to the original to release the cutoff state and the state in which the power receiving unit 3 is mounted on the plate 5 of the power transmitting unit 2 can be reproduced in a pseudo manner. With these pseudo reproductions (removal→mounting), the operation of starting charging the power transmitting unit 2 (Step S105) can be restarted.

Therefore, in the present embodiment, an advantage is obtained such that a command for recharging is not required. With this, a merit can be obtained such that functions of transmitting and receiving a recharging command are not required to be provided to the power transmitting unit 2 and the power receiving unit 3 and the structure can be simplified.

The present invention can be applied not only to a movable-coil-type charging system as in the embodiment but also a non-movable-coil-type charging system (a charging system of a type in which the coil of the power transmitting unit does not move). This is because charging starts in either charging system only by mounting the power receiving unit on the power transmitting unit.

In more detailed description, this is because, in the movable-coil-type charging system, as is the embodiment described above, when the power receiving unit 3 is mounted on the power transmitting unit 2, the mount position of the power receiving unit 3 is detected in response to the mounting and the power transmitting coil 13 is moved to the mount position to start charging, and charging (recharging) starts similarly even when removal and mounting of the power receiving unit 3 are performed in a pseudo manner.

The same goes for a non-movable-coil type charging system. This is because, since charging starts only by mounting the power receiving unit on the power transmitting unit, charging (recharging) starts similarly even when removal and mounting of the power receiving unit 3 are performed in a pseudo manner.

As such, according to the embodiment, a command for recharging is not required and the structure can be simplified. Furthermore, a technology excellent in versatility that can be widely applied to a non-contact-type charging system, irrespectively of a movable coil type or a non-movable coil type, can be provided.

Note that while a movable-coil-type charging system is taken as an example for description in the above description, it goes without saying that the idea of the embodiment can be applied to a non-movable-coil-type charging system, that is, a charging system of a type in which the coil of the power transmitting unit does not move.

Also, the power receiving unit 3 is not limited to a portable telephone such as a smartphone. Any electronic apparatus may be used as long as the electronic apparatus supports a non-contact-type charging system and includes any load element operating with the secondary battery 20.

Furthermore, while recharging after full charge is performed in the above description, recharging is not limited thereto. For example, recharging (restart of charging) after charging stops with an anomaly in charging operation (such as an anomaly in temperature of the secondary battery) may be performed.

Features of the present invention are described below as supplementary notes.

The whole or part of the embodiment described above can be described as, but not limited to, the following supplementary notes.

### (Supplementary Note 1)

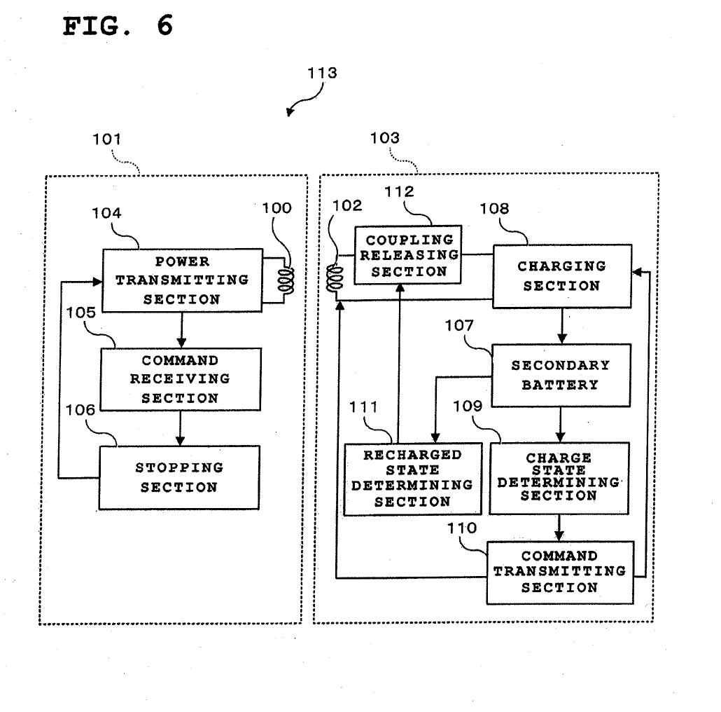

FIG. 6 is a structural diagram of Supplementary Note 1.

As depicted in this drawing, Supplementary Note 1 provides a charging system 113 (corresponding to the charging system 1 of the embodiment) comprising a power transmitting unit 101 (corresponding to the power transmitting unit 2 of the embodiment) including a power transmitting coil 100 (corresponding to the power transmitting coil 13 of the embodiment) and a power receiving unit 103 (corresponding to the power receiving unit 3 of the embodiment) including a power receiving coil 102 (corresponding to the power receiving coil 14 of the embodiment) that can be coupled to the power transmitting coil 100 by electromagnetic induction,

the power transmitting unit 101 including

power transmitting means 104 (corresponding to the transmission circuit 16 of the embodiment) driving the power transmitting coil 100 when the power receiving coil 102 is positioned near the power transmitting coil 100 and transmitting electric power to the power receiving coil 102,

command receiving means 105 (corresponding to the power transmission circuit 16 of the embodiment) receiving a predetermined command transmitted from the power receiving unit 103, and

stopping means 106 (corresponding to the control circuit 17 of the embodiment) stopping a power transmitting operation of the power transmitting means 104 when the predetermined command is received, and

the power receiving unit 103 including

charging means 108 (corresponding to the charging circuit 19 of the embodiment) charging a secondary battery 107 (corresponding to the secondary battery 20 of the embodiment) by using a current induced in the power receiving coil 102,

fully-charged state determining means 109 (corresponding to the control circuit 19a of the embodiment) monitoring a charge state of the secondary battery 107 to determine whether the secondary battery 107 is in a fully-charged state,

command transmitting means 110 (corresponding to the control circuit 19a of the embodiment) stopping the charging means 108 from performing an operation of charging the secondary battery 107 when it is determined by the fully-charged state determining means 109 that the secondary battery 107 is in the fully-charged state and transmitting the predetermined command to the power transmitting unit 101,

recharged state determining means 111 (corresponding to the control circuit 19a of the embodiment) determining, while charging of the secondary battery 107 is being stopped, whether the secondary battery 107 is in a state requiring recharging, and

cutoff means 112 (corresponding to the cutoff means 24 of the embodiment) temporarily cutting off the power receiving coil 102 from a circuit when it is determined by the recharge determining means 111 that the secondary battery 107 is in the state requiring recharging.

### (Supplementary Note 2)

Supplementary Note 2 provides the charging system according to Supplementary Note 1, wherein the power transmitting coil is a movable coil moving to a position of the power receiving coil.

### (Supplementary Note 3)

Supplementary Note 3 provides an electronic apparatus comprising:

a power receiving coil that can be coupled to a power transmitting coil of a power transmitting unit by electromagnetic induction,

charging means charging a secondary battery by using a current induced in the power receiving coil,

fully-charged state determining means monitoring a charge state of the secondary battery to determine whether the secondary battery is in a fully-charged state,

command transmitting means stopping the charging means from performing an operation of charging the secondary battery when it is determined by the fully-charged state determining means that the secondary battery is in the fully-charged state and transmitting to the power transmitting unit a command for making an instruction for stopping electric power transmission,

recharge determining means determining, while charging of the secondary battery is being stopped, whether the secondary battery is in a state requiring recharging, and

cutoff means temporarily cutting off the power receiving coil from a circuit when it is determined by the recharge determining means that the secondary battery is in the state requiring recharging.

### (Supplementary Note 4)

Supplementary Note 4 provides a charge control method comprising:

a charging step of charging a secondary battery by using a current induced in a power receiving coil;

a fully-charged state determining step of monitoring a charge state of the secondary battery to determine whether the secondary battery is in a fully-charged state;

a command transmitting step of stopping the charging step from performing an operation of charging the secondary battery when it is determined in the fully-charged state determining step that the secondary battery is in the fully-charged state and transmitting a command making an instruction for stopping a power transmitting unit from transmitting electric power;

a recharge determining step of determining, while charging of the secondary battery is being stopped, whether the secondary battery is in a state requiring recharging; and

a cutoff step of temporarily cutting off the power receiving coil from a circuit when it is determined in the recharge determining step that the secondary batter is in the state of requiring recharging.

### (Supplementary Note 5)

Supplementary Note 5 provides a program providing functions to a computer of a power receiving unit having a power receiving coil that can be coupled to a power transmitting coil of a power transmitting unit by electromagnetic induction, the function comprising:

charging means charging a secondary battery by using a current induced in the power receiving coil,

fully-charged state determining means monitoring a charge state of the secondary battery to determine whether the secondary battery is in a fully-charged state,

command transmitting means stopping the charging means from performing an operation of charging the secondary battery when it is determined by the fully-charged state determining means that the secondary battery is in the fully-charged state and transmitting to the power transmitting unit a command for making an instruction for stopping electric power transmission,

recharge determining means determining, while charging of the secondary battery is being stopped, whether the secondary battery is in a state requiring recharging, and

cutoff means temporarily cutting off the power receiving coil from a circuit when it is determined by the recharge determining means that the secondary battery is in the state requiring recharging.

### DESCRIPTION OF REFERENCE NUMERALS

100 power transmitting coil
101 power transmitting unit
102 power receiving coil
103 power receiving unit
104 power transmitting means
105 command receiving means
106 stopping means
107 secondary battery
108 charging means
109 fully-charged state determining means
110 command transmitting means
111 recharged state determining means
112 cutoff means
113 charging system

1. A charging system comprising:
a power transmitting unit including a power transmitting coil and a power receiving unit including a power receiving coil that can be coupled to the power transmitting coil by electromagnetic induction,
the power transmitting unit including
power transmitting section driving the power transmitting coil when the power receiving coil is positioned near the power transmitting coil and transmitting electric power to the power receiving coil,
command receiving section receiving a predetermined command transmitted from the power receiving unit, and
stopping section stopping a power transmitting operation of the power transmitting section when the predetermined command is received, and
the power receiving unit including
charging section charging a secondary battery by using a current induced in the power receiving coil,
charge state determining section monitoring a charge state of the secondary battery to determine whether the secondary battery is in a state that charging of the secondary battery is required to be stopped,
command transmitting section stopping the charging section from performing an operation of charging the secondary battery when it is determined by the charge state determining section that the secondary battery is in a state that charging of the secondary battery is required to be stopped and transmitting the predetermined command to the power transmitting unit,
recharge determining section determining, while charging of the secondary battery is being stopped, whether the secondary battery is in a state requiring recharging, and
coupling releasing section temporarily releasing coupling of the power receiving coil and the power transmitting coil by electromagnetic induction when it is determined by the recharge determining section that the secondary battery is in the state requiring recharging.

2. The charging system according to claim 1, wherein the power transmitting coil is a movable coil moving to a position of the power receiving coil.

3. An electronic apparatus comprising:
a power receiving coil that can be coupled to a power transmitting coil of a power transmitting unit by electromagnetic induction,
charging section charging a secondary battery by using a current induced in the power receiving coil,
charge state determining section monitoring a charge state of the secondary battery to determine whether the secondary battery is in a state that charging of the secondary battery is required to be stopped,
command transmitting section stopping the charging section from performing an operation of charging the secondary battery when it is determined by the charge state determining section that the secondary battery is in a state that charging of the secondary battery is required to be stopped and transmitting to the power transmitting unit a command for making an instruction for stopping electric power transmission,
recharge determining section determining, while charging of the secondary battery is being stopped, whether the secondary battery is in a state requiring recharging, and
coupling releasing section temporarily releasing coupling of the power receiving coil and the power transmitting coil by electromagnetic induction when it is determined by the recharge determining section that the secondary battery is in the state requiring recharging.

4. A charge control method comprising:
a charging step of charging a secondary battery by using a current induced in a power receiving coil;
a charge state determining step of monitoring a charge state of the secondary battery to determine whether the secondary battery is in a state that charging of the secondary battery is required to be stopped;
a command transmitting step of stopping the charging step from performing an operation of charging the secondary battery when it is determined in the charge state determining step that the secondary battery is in a state that charging of the secondary battery is required to be stopped and transmitting a command making an instruction for stopping a power transmitting unit from transmitting electric power;
a recharge determining step of determining whether the secondary battery is in a state requiring recharging while charging of the secondary battery is being stopped; and
a coupling releasing step of temporarily releasing coupling of the power receiving coil and the power transmitting coil by electromagnetic induction when it is determined in the recharge determining step that the secondary battery is in the state of requiring recharging.

5. A non-transitory computer-readable storage medium having a program stored thereon that is executable by a computer in a power receiving unit having a power receiving coil that can be coupled to a power transmitting coil of a power transmitting unit by electromagnetic induction, the program causing the computer to perform functions comprising:
a charging section charging a secondary battery by using a current induced in the power receiving coil,
a charge state determining section monitoring a charge state of the secondary battery to determine whether the secondary battery is in a state that charging of the secondary battery is required to be stopped,
a command transmitting section stopping the charging section from performing an operation of charging the secondary battery when it is determined by the charge state determining section that the secondary battery is in a state that charging of the secondary battery is required to be stopped and transmitting to the power transmitting unit a command for making an instruction for stopping electric power transmission,
a recharge determining section determining whether the secondary battery is in a state requiring recharging while charging of the secondary battery is being stopped, and
a coupling releasing section temporarily releasing coupling of the power receiving coil and the power transmitting coil by electromagnetic induction when it is determined by the recharge determining section that the secondary battery is in the state requiring recharging.

6. The charging system according to claim 1, wherein the coupling releasing means temporarily releases the coupling of the power receiving coil and the power transmitting coil by electromagnetic induction, by temporarily cutting off the power receiving coil from a circuit.

7. The charging system according to claim 1, wherein the coupling releasing means temporarily releases the coupling of the power receiving coil and the power transmitting coil by electromagnetic induction, by making a switch element inserted between the power receiving coil and the power transmitting coil temporarily become in a release state.
